(19) United States
(12) Patent Application Publication
(10) Pub. No.: US 2024/0423233 A1
(43) Pub. Date: Dec. 26, 2024

(54) CHOCOLATE DRINK COMPOSITION

(71) Applicant: LCC CONCEPT, Paris (FR)

(72) Inventor: Hani ROUMIER, Paris (FR)

(21) Appl. No.: 18/699,201

(22) PCT Filed: Oct. 4, 2022
(86) PCT No.: PCT/EP2022/077567

§ 371 Date: Apr. 5, 2024

(30) Foreign Application Priority Data
Oct. 8, 2021 (FR) FR2110674

(51) Int. Cl. A23G 1/56; A23C 11/02; A23G 1/48; A23L 7/10

(52) U.S. Cl. CPC A23G 1/56; A23C 11/02; A23G 1/48; A23L 7/10

(57) ABSTRACT

The present invention relates to a chocolate beverage composition, comprising at least 33 wt % of couverture chocolate, and at least 50% by weight of a vegetal milk, the chocolate beverage composition having a viscosity measured at 70° C. of between 150 mPa·s and 500 mPa·s.

### FIELD OF INVENTION

The present invention relates to a chocolate drink composition.

More specifically, the invention relates to a smooth chocolate drink composition, free from milk of animal origin or from product derived from animal milk.

### TECHNOLOGY BACKGROUND

In the field of chocolate drinks, it is known to prepare hot chocolate type drinks by melting couverture chocolate or even cocoa powder or chocolate powder in heated cow milk or in heated cow milk cream, or in a mixture of milk and cream.

With the commonly used proportions and operating methods, that is to say a significant proportion of milk, the drink is liquid, with a very low viscosity. It is therefore not perceived as smooth.

In addition, such preparations are not very stable with respect to changes in temperature and over time.

The phases of the emulsion tend to separate, either simply over time, or due to storage at room temperature or in the refrigerator, so that we observe that the product “slices”, that is to say that it does not remain macroscopically homogeneous.

It is possible to increase the viscosity of such a chocolate drink by increasing the proportion of cream.

However, we note that cream of animal origin, as well as milk of animal origin, interfere with the taste of chocolate, and generally tend to mask this taste. The organoleptic qualities of the chocolate drink due to the used chocolate therefore decrease when the proportion of cream increases.

Furthermore, the drink thus obtained is not suitable for people with an allergy or intolerance to lactose or to the proteins of the animal milk used.

To overcome this drawback, it is known to replace dairy products of animal origin with products of vegetal origin.

For this, the most common drinks are soy and oat drinks, as well as, and to a lesser extent, almond milk, coconut milk, or a rice drink. These drinks are generally used either to be consumed plain, cold or hot, to replace milk, or to accompany coffee and/or tea.

Concerning chocolate drinks, vegetal drinks form the basis of chocolate-flavored drinks, with a low cocoa content, intended for a “vegan” alternative to milk-based chocolate drinks.

Concerning hot chocolate type drinks with a high cocoa content, vegetal drinks are not commonly used today. The alternative to animal milk, which is not very common, is water to replace milk. These products are not very smooth, and such as with milk, the emulsion phases tend to separate. In addition, the organoleptic qualities of chocolate are marked by a watery taste.

In cases where the taste of the vegetal milk is strong (coconut, almond) and where the proportion of vegetal milk is high, this taste can interfere with the taste of the used chocolate, thus degrading the taste experience in terms of chocolate.

Furthermore, the chocolate drinks thus obtained are also liquid, of low viscosity and therefore not very smooth.

To obtain a thicker texture, that is to say a higher viscosity, it is known to use thickeners, in particular pectin or starch.

Thus, American patent application US 2011/0274813 discloses a liquid or semi-liquid chocolate food product composition containing a high proportion of rice starch, the starch being provided in the form of a starch gel. The composition of American patent application US 2011/0274813 comprises 20% to 50% by mass of water, 0.5% to 10% by mass of rice starch gel and 50% to 80% by mass of a chocolate base. The chocolate base is a mass comprising at least one cocoa component, for example cocoa powder, a sweetening agent—such as for example sucrose, glucose or fructose—or a sweetener, and optionally an emulsifier and/or a product derived from milk.

The drink disclosed in this document, in particular in Example 3, is formed from a rice starch gel and a relatively low content of chocolate (of the order of 10%), which results in a thick drink but which does not have the smooth character of drinks made from animal milk. The drink, even after reheating, is perceived as pasty rather than smooth.

The invention thus aims to propose a chocolate drink composition without animal milk or product derived from such milk, in which the organoleptic qualities of the used chocolate are maintained, forming an emulsion stable over time and with respect to changes in the temperature, this emulsion being perceived as smooth but not pasty by the consumer.

### SUMMARY OF THE INVENTION

Thus, the invention relates to a chocolate drink composition, comprising:
at least 33% by weight of couverture chocolate, and
at least 50% by weight of a vegetal milk, the chocolate drink composition having a viscosity measured at 70° C. of between 150 mPa·s and 500 mPa·s. Thanks to these provisions, a chocolate drink having an intense chocolate taste, due to the use of couverture chocolate, and the high content of this couverture chocolate in the chocolate drink.

The chocolate drink also has a particular smoothness at consumption temperature, for example at 70° C., and is obtained without using products derived from milk of animal origin, such as cow milk and cream.

Depending on different aspects, it is possible to provide one and/or the other of the characteristics below taken alone or in combination.

According to one embodiment, the couverture chocolate has a cocoa content of at least 40%. Thus, the chocolate taste can be expressed intensely in the drink.

According to one embodiment, the vegetal milk is chosen from a milk obtained from cereals, a milk obtained from oleaginous fruits, a milk obtained from legumes, or a mixture of these. Such vegetal milks contain a low proportion of starch, low enough not to obtain a pasty texture but high enough to obtain, in association with the couverture chocolate, a particularly smooth texture of the chocolate drink.

According to one embodiment, vegetal milk is milk obtained from cereals, with the exception of soy milk. It has in fact been observed that soy milk gives a pasty texture to the chocolate drink. On the other hand, other vegetal milks made from cereals have a relatively neutral taste. Consequently, the taste of the chocolate drink is particularly close to the taste of the couverture chocolate that was used in the composition of this drink.

According to one embodiment, the cereal milk comprises at least 10% by weight of cereals and at least 80% by weight of water. Thanks to this arrangement, the starch content is adapted to obtain the desired smooth texture.

According to one embodiment, the chocolate drink composition further comprises cocoa butter.

According to one embodiment, the chocolate drink composition further comprises an additional agent chosen from a sweetening agent, a flavoring agent, a flavor enhancer, cocoa butter and a mixture of these.

Thanks to this arrangement, it is possible to offer chocolate drink compositions combining the taste of a couverture chocolate and another taste on the same principle as chocolate candies, bites or bars. We can thus offer drinks with an intense chocolate taste and whose taste also includes a fruit note, a honey note, a spice note or a drinkable alcohol note.

According to one embodiment, the chocolate drink composition is free of milk and/or milk derivatives of animal origin.

Thanks to this provision, the chocolate drink is suitable for people with an allergy or intolerance to milk of animal origin.

According to one embodiment, the dynamic viscosity of the chocolate drink measured at 25° C. is between 1500 mPa·s and 3000 mPa·s.

Thanks to this arrangement, the chocolate drink is a macroscopically homogeneous emulsion and stable at room temperature, so that it does not slice upon cooling.

The invention further relates to a method for preparing a chocolate drink composition comprising the steps consisting of:
a) mixing at least one couverture chocolate and a vegetal milk,
b) heating the mixture obtained in step a) at a temperature of at least 75° C.,
c) homogenize the mixture.

It has in fact been observed that the temperature of step b is ideal for obtaining a particularly smooth consistency.

### DETAILED DESCRIPTION

The invention relates to a milk-free chocolate drink composition of animal origin or product derived from such milk, as well as the corresponding preparation process. Advantageously, the present invention relates to a chocolate drink composition, comprising:
at least 33% by weight of couverture chocolate, and
at least 50% by weight of a vegetal milk, said chocolate drink composition having a viscosity measured at 70° C. of between 100 mPa·s and 500 mPa·s.

For the purposes of the present invention, the terms “chocolate drink composition” and “chocolate drink” or “dark chocolate drink” can be used interchangeably.

The beverage composition according to the invention is perceived by the consumer as smooth in a wide range of consumption temperatures, in particular at room temperature, in particular at a temperature of 15° C. to 25° C., but also after reheating, in particular up to a temperature of around 70° C.

It presents, in addition to its smoothness, high organoleptic qualities. In particular, its taste is close to the taste of the chocolate which was used in its preparation.

To the extent that the composition of a chocolate drink aims to allow the consumer to enjoy a drink whose taste reflects as faithfully as possible the taste of the chocolate which was used in its preparation, this chocolate must be a high quality chocolate.

For the purposes of the present invention, the term “couverture chocolate” means a chocolate containing at least 35% total cocoa solids, including at least 31% cocoa butter and at least 2.5% defatted dry cocoa, in accordance with the composition rules determined by European Directive 2000/36/EC of Jun. 23, 2000 relating to cocoa and chocolate products intended for human consumption.

Different couverture chocolates, or even mixtures of such chocolates, can be used so as to obtain beverage compositions according to the invention with different tastes.

According to a particular embodiment of the invention, the couverture chocolate used in the beverage composition according to the invention may be a dark chocolate, a milk chocolate or a white chocolate or a mixture of these, provided that the milk used in chocolate, if it contains any, is not milk and/or milk-derived products of animal origin.

According to a particular embodiment of the invention, the couverture chocolate may possibly contain traces of milk and/or products derived from milk of animal origin, that is to say a content of one or more products derived from milk of animal origin above the detection limit but below the quantification limit of the detection method used. Advantageously, the content of milk and/or product derived from milk of animal origin is less than 1.0 g/kg of couverture chocolate, advantageously less than 900 mg/kg, advantageously less than 800 mg/kg, advantageously less than 700 mg/kg, advantageously less than 600 mg/kg, advantageously less than 500 mg/kg, advantageously less than 400 mg/kg, advantageously less than 300 mg/kg, advantageously less than 200 mg/kg, advantageously less than 100 mg/kg, advantageously less than 90 mg/kg, advantageously less than 80 mg/kg, advantageously less than 70 mg/kg, advantageously less than 60 mg/kg, advantageously less than 50 mg/kg, advantageously less than 40 mg/kg, advantageously less than 30 mg/kg, advantageously less than 20 mg/kg, advantageously less than 10 mg/kg, advantageously less than 5 mg/kg, advantageously less than 1 mg/kg of couverture chocolate. Advantageously, the couverture chocolate does not contain any milk and/or product derived from milk of animal origin.

Advantageously, the couverture chocolate is completely free of milk and/or product derived from milk of animal origin. In a particular embodiment of the invention, the couverture chocolate has a cocoa content of at least 40%.

For the purposes of the present invention, the cocoa content corresponds to the percentage by weight of all products derived from the cocoa bean used in the manufacture of chocolate, namely cocoa mass, cocoa butter and cocoa in itself. According to a particular embodiment of the invention, the couverture chocolate has a cocoa content of the couverture chocolate, greater than or equal to 40%, advantageously greater than or equal to 43%, advantageously greater than or equal to 45%, advantageously greater or equal to 50%, advantageously greater than or equal to 55%, advantageously greater than or equal to 56%, advantageously greater than or equal to 57%, advantageously greater than or equal to 58%, advantageously greater than or equal to 59%, advantageously greater than or equal at 60%, advantageously greater than or equal to 61%, advantageously greater than or equal to 62%, advantageously greater than or equal to 63%, advantageously greater than or equal to 64%, advantageously greater than or equal to 65%, advantageously greater than or equal to 66%, advantageously greater than or equal to 67%, advantageously greater than or equal to 68%, advantageously greater than or equal to 69%, advantageously greater than or equal to 70%, advantageously greater than or equal to 71%, advantageously greater than or equal to 72%, advantageously greater than or equal to 73%, advantageously greater than or equal to 74%, advantageously greater than or equal to 75%, advantageously greater than or equal to 76%, advantageously greater than or equal to 77%, advantageously greater than or equal to 78%, advantageously greater or equal to 79%, advantageously greater than or equal to 80%, advantageously greater than or equal to 81%, advantageously greater than or equal to 82%, advantageously greater than or equal to 83%, advantageously greater than or equal to 84%, advantageously greater than or equal at 85%, advantageously greater than or equal to 86%, advantageously greater than or equal to 87%, advantageously greater than or equal to 88%, advantageously greater than or equal to 89%, advantageously greater than or equal to 90%, advantageously greater than or equal to 91%, advantageously greater than or equal to 92%, advantageously greater than or equal to 93%, advantageously greater than or equal to 94%, advantageously greater than or equal to 95%, advantageously greater than or equal to 96%, advantageously greater than or equal to 97%, advantageously greater than or equal to 98%, advantageously greater than or equal to 99%, advantageously greater than or equal to 100%, the percentage being expressed in relation to the total sum of ingredients present in the couverture chocolate.

According to one embodiment of the invention, the cocoa content of the couverture chocolate according to the invention is between 40% and 100% by weight relative to the total weight of the couverture chocolate. Advantageously, the cocoa content of the couverture chocolate according to the invention is between 43% and 100% by weight, advantageously 40% and 95% by weight, advantageously between 45% and 90% by weight, advantageously between 45% and 85% by weight, advantageously between 50% and 80% by weight, advantageously between 55% and 80% by weight, advantageously between 60% and 80% by weight, advantageously between 60% and 75% by weight, advantageously between 64% and 75% by weight relative to the total weight of the couverture chocolate. In a particularly advantageous embodiment of the invention, the couverture chocolate has a cocoa content of at least 60%, advantageously greater than or equal to 64%, advantageously between 64% and 75% by weight relative to the total weight of couverture chocolate.

Advantageously, the couverture chocolate can thus be a chocolate with a high cocoa butter content. Advantageously, the cocoa butter content present in the couverture chocolate is at least 23% by weight, advantageously at least 24% by weight, advantageously at least 25% by weight, advantageously at least 26% by weight advantageously at least 27% by weight, advantageously at least 28% by weight, advantageously at least 29% by weight, advantageously at least 30% by weight, advantageously at least 31% by weight, advantageously at least 32% by weight, advantageously at least 33% by weight, advantageously at least 34% by weight, advantageously at least 35% by weight, advantageously at least 36% by weight advantageously at least 37% by weight, advantageously at least 38% by weight, advantageously at least 39% by weight, advantageously at least 40% by weight, advantageously at least 41% by weight, advantageously at least 42% by weight, advantageously at least 43% by weight, advantageously at least 44% by weight, advantageously at least 45% by weight, advantageously at least 46% by weight advantageously at least 47% by weight, advantageously at least 48% by weight, advantageously at least 49% by weight, advantageously at least 50% by weight, advantageously at least 51% by weight, advantageously at least 52% by weight, advantageously at least 53% by weight, advantageously at least 54% by weight, advantageously at least 55% by weight, advantageously at least 56% by weight advantageously at least 57% by weight, advantageously at least 58% by weight, advantageously at least 59% by weight, advantageously at least 60% by weight, advantageously at least 61% by weight, advantageously at least 62% by weight, advantageously at least 63% by weight, advantageously at least 64% by weight, advantageously at least 65% by weight, or more, the percentage being expressed in relation to the weight of all the ingredients present in the couverture chocolate. Advantageously, the cocoa butter content present in the couverture chocolate is at least 43% by weight relative to the weight of all the ingredients present in the couverture chocolate. Advantageously, the cocoa butter content present in the couverture chocolate is 43% by weight relative to the weight of all the ingredients present in the couverture chocolate. Advantageously, the cocoa butter content present in the couverture chocolate is at least 46% by weight relative to the weight of all the ingredients present in the couverture chocolate. Advantageously, the cocoa butter content present in the couverture chocolate is 46% by weight relative to the weight of all the ingredients present in the couverture chocolate. Advantageously, the cocoa butter content present in the couverture chocolate is at least 49% by weight relative to the weight of all the ingredients present in the couverture chocolate. Advantageously, the cocoa butter content present in the couverture chocolate is 49% by weight relative to the weight of all the ingredients present in the couverture chocolate. Advantageously, the cocoa butter content present in the couverture chocolate is between 23% and 65%, advantageously between 31% and 59% by weight, advantageously between 35% and 55% by weight, advantageously between 40% and 50% by weight, advantageously 43% and 49% by weight relative to the weight of all the ingredients present in the couverture chocolate.

The couverture chocolate is advantageously in a solid form and can be in the form of particles, granules, pastilles, tablets and/or powder. The choice between these different shapes is simply guided by the ease of producing the chocolate drink composition from one or the other of these shapes.

The liquid character of the chocolate drink composition is obtained by mixing the couverture chocolate and the vegetal milk.

Advantageously, the chocolate drink composition according to the invention comprises at least 33% by weight of couverture chocolate and at least 50% by weight of a vegetal milk. Comparison of sample 2 with sample 7 of example 5 allows us to conclude that the content of couverture chocolate, all other things being equal, is essential to obtain the desired viscosity at 70° C. The example of sample 7 shows in particular that a proportion of couverture chocolate equal to 25% by mass is not sufficient to obtain satisfactory smoothness at 70° C., whereas a proportion of 38% by mass (sample 2) is, with a maximum temperature reached of 80° C. during the process of preparing the chocolate drink composition.

Advantageously, the chocolate drink composition consists essentially of at least 33% by weight of couverture chocolate and at least 50% by weight of a vegetal milk.

Advantageously, the chocolate drink composition consists of at least 33% by weight of couverture chocolate and at least 50% by weight of a vegetal milk.

In an advantageous embodiment of the invention, the content of couverture chocolate present in the chocolate drink composition represents at least 34% by weight, advantageously at least 34.5% by weight, advantageously at least 35% by weight, advantageously at least 35.5% by weight, advantageously at least 35.7% by weight, advantageously at least 36% by weight, advantageously at least 36.5% by weight, advantageously at least 37% by weight, advantageously at least 37.5% by weight, advantageously at least 38% by weight, advantageously at least 38.5% by weight, advantageously at least 39% by weight, advantageously at least 39.5% by weight, advantageously at least 40% by weight, advantageously at least 40.5% by weight, advantageously at least 41% by weight, advantageously at least 41.5% by weight, advantageously at least 42% by weight, advantageously at least 42.5% by weight, advantageously at least 43% by weight, advantageously at least 435% by weight, advantageously at least 44% by weight, advantageously at least 44.5% by weight, advantageously at least 45% by weight relative to the total weight of the chocolate drink composition. Advantageously, the couverture chocolate content is between 33% and 45% by weight, advantageously between 33% and 42% by weight, advantageously between 33% and 40% by weight, advantageously between 33% and 39% by weight, advantageously between 33% and 38.5% by weight, advantageously between 34.5% and 38.5% by weight, advantageously between 34% and 36% by weight relative to the total weight of the chocolate drink composition. Advantageously, the couverture chocolate content is 35.7% by weight relative to the weight of the chocolate drink composition. Advantageously, the couverture chocolate content is 38.5% by weight relative to the weight of the chocolate drink composition.

In an advantageous embodiment of the invention, the vegetal milk content present in the chocolate drink composition represents at least 51% by weight, advantageously at least 51.5% by weight, advantageously at least 52% by weight, advantageously at least 52.5% by weight, advantageously at least 53% by weight, advantageously at least 53.5% by weight, advantageously at least 54% by weight, advantageously at least 54.5% by weight, advantageously at least 55% by weight, advantageously at least 55.5% by weight, advantageously at least 56% by weight, advantageously at least 56.5% by weight, advantageously at least 57% by weight, advantageously at least 57.5% by weight, advantageously at least 58% by weight, advantageously at least 58.5% by weight, advantageously at least 59% by weight, advantageously at least 59.5% by weight, advantageously at least 60% by weight, advantageously at least 60.5% by weight, advantageously at least 61% by weight, advantageously at least 61.5% by weight, advantageously at least 62% by weight, advantageously at least 62.5% by weight, advantageously at least 63% by weight, advantageously at least 63.5% by weight, advantageously at least 64% by weight, advantageously at least 64.3% by weight, advantageously at least 64.5% by weight, advantageously at least 65% by weight, advantageously at least 65.5% by weight, advantageously at least 66% by weight, advantageously at least 66.5% by weight, advantageously at least 67% by weight, advantageously at least 67.5% by weight, advantageously at least 68% by weight, advantageously at least 68.5% by weight, advantageously at least 69% by weight, advantageously at least 69.5% by weight, advantageously at least 70% by weight relative to the total weight of the chocolate drink composition. Advantageously, the vegetal milk content is between 50% and 70% by weight, advantageously between 50% and 69% by weight, advantageously between 50% and 68% by weight, advantageously between 50% and 67% by weight, advantageously between 50% and 66% by weight, advantageously between 50% and 65% by weight relative to the total weight of the chocolate drink composition.

Advantageously, the vegetal milk content is 64.3% by weight relative to the weight of the chocolate drink composition. Advantageously, the vegetal milk content is 61.5% by weight relative to the weight of the chocolate drink composition.

In one embodiment, the ratio R of the initial masses of vegetal milk and couverture chocolate is at least 1.2:1, that is to say 120 g of vegetal milk per 100g of couverture chocolate.

Advantageously, the ratio R of the initial masses of vegetal milk and couverture chocolate is at least 1.25:1, advantageously at least 1.30:1, advantageously at least 1.35:1, advantageously at least 1.40:1, advantageously at least 1.45:1, advantageously at least 1.50:1, advantageously at least 1.55:1, advantageously at least 1.60:1, advantageously at least 1.65:1, advantageously at least 1.70:1, advantageously at least 1.75:1, advantageously at least 1.80:1, advantageously at least 1.85:1, advantageously at least 1, 90:1, advantageously at least 1.95:1, advantageously at least 2.0:1.

Advantageously, the ratio R of the initial weights of vegetal milk and couverture chocolate is between 1.2:1 and 2.0:1, advantageously between 1.4:1 and 1.9:1, advantageously between 1.5:1 and 1.85:1, advantageously between 1.55:1 and 1.65:1, advantageously between 1.75:1 and 1.85:1. In a particularly advantageous embodiment of the invention, the chocolate drink composition comprises between 33% and 45% by weight of couverture chocolate and between 50% and 70% by weight of a vegetal milk.

In a particularly advantageous embodiment of the invention, the chocolate drink composition comprises 35.7% by weight of couverture chocolate and 64.3% by weight of a vegetal milk. Advantageously, the chocolate drink composition consists essentially of 35.7% by weight of couverture chocolate and 64.3% by weight of a vegetal milk. Advantageously, the chocolate drink composition consists of 35.7% by weight of couverture chocolate and 64.3% by weight of a vegetal milk.

In another particularly advantageous embodiment of the invention, the chocolate drink composition comprises 38.5% by weight of couverture chocolate and 61.5% by weight of a vegetal milk. Advantageously, the chocolate drink composition consists essentially of 38.5% by weight of couverture chocolate and 61.5% by weight of a vegetal milk. Advantageously, the chocolate drink composition consists of 38.5% by weight of couverture chocolate and 61.5% by weight of a vegetal milk.

The inventors observed in particular on a test panel of consumers that a ratio of the weight of vegetal milk and couverture chocolate of between 1.5:1 and 1.85:1 presents very satisfactory organoleptic qualities. In fact, consumers perceived as smooth the consistency of the chocolate drink compositions comprising respectively 35.7% by weight of couverture chocolate and 64.3% by weight of vegetal milk, i.e. an R ratio of 1.8 and 38.5% by weight of couverture chocolate and 61.5% by weight of vegetal milk, i.e. an R ratio of 1.6.

More precisely, the range of ratios R between 1.75 and 1.85, in which sample 2 is located, makes it possible to obtain a chocolate drink composition with an intense chocolate taste suitable for a majority of consumers and the range of R ratios between 1.55 and 1.65, in which the samples 1 and 6 are located, allows you to obtain a chocolate drink composition with a very intense chocolate taste, particularly suitable for lovers of very strong chocolate.

Advantageously, the vegetal milk contained in the chocolate drink composition can be chosen from a milk obtained from cereals, a milk obtained from oleaginous fruits, a milk obtained from legumes or a mixture of these.

Such vegetal milk is sometimes called a “vegetal drink” in commerce or culinary recipes. It can for example be “almond milk”, “coconut milk”, “rice drink”, “oat drink”.

For example, cereals used to prepare vegetal milk may include rice, oats, wheat, barley, and malt.

For example, oleaginous fruits include nuts such as walnuts, almonds, hazelnuts, and pistachios, but also coconut.

For example, legumes are advantageously protein legumes such as lentils or peas.

According to one embodiment of the invention, the vegetal milk may comprise a mixture of cereals and/or oilseed fruits and/or legumes, as defined above.

According to one embodiment of the invention, the vegetal milk comprises at least 80% by weight of water and at least 10% by weight of a vegetal chosen from a cereal, an oleaginous fruit, a protein legume and a mixture of these.

Advantageously, the vegetal milk comprises at least 11% by weight, advantageously at least 12% by weight, advantageously at least 13% by weight, advantageously at least 14% by weight, advantageously at least 15% by weight, advantageously at least 16% by weight, advantageously at least 17% by weight, advantageously at least 18% by weight, advantageously at least 19% by weight of vegetal relative to the total weight of the vegetal milk.

According to a particularly advantageous embodiment of the invention, vegetal milk is milk obtained from cereals, with the exception of soy milk. Indeed, the inventors have shown that the use of soy milk does not make it possible to obtain a chocolate drink composition having a smooth consistency, the soy milk giving a pasty consistency to the composition. In addition, the use of soy milk, in addition to its texture, gives the chocolate drink composition a very marked taste, disrupting the organoleptic balance of said chocolate drink for the consumer. In a particularly advantageous embodiment of the invention, the vegetal milk is rice milk.

According to a particular embodiment of the invention, the vegetal milk according to the invention is a cereal milk, comprising at least 10% by weight of cereals and at least 80% by weight of water.

Advantageously, the vegetal milk comprises at least 11% by weight, advantageously at least 12% by weight, advantageously at least 13% by weight, advantageously at least 14% by weight, advantageously at least 15% by weight, advantageously at least 16% by weight, advantageously at least 17% by weight, advantageously at least 18% by weight, advantageously at least 19% by weight of cereals relative to the total weight of the vegetal milk.

The vegetal can be provided in the vegetal milk in the form of cereal grains (or protein legume seeds) whole or crushed or mixed or reduced to powder, from which the bark has been removed at least partially or not.

In the case of oilseed fruits, these can be shelled and/or reduced to powder.

Vegetal milk can be obtained according to a process comprising a soaking step or an infusion step and/or a decoction step in water of the vegetal.

Advantageously, the process may further comprise a mixing step and/or a filtration step of the product resulting from the soaking, infusion or decoction step.

Vegetal milk can be obtained by soaking oleaginous fruits, for example almonds, in water. For example, almond milk is obtained by a process comprising a step of soaking powdered almonds for 8 to 12 hours in mineral water at room temperature followed by a step of draining and mixing the powder with mineral water at room temperature allows to obtain almond milk.

Vegetal milk can also be obtained by infusion or decoction of cereals, for example oat flakes or rice grains, in water.

For example, a step of soaking rice grains for 24 hours followed by a draining step, a step of cooking the rice grains for 4 to 10 minutes in water brought to a boil, a step of mixing the rice-water mixture and finally a step of filtering the mixture to recover the filtrate makes it possible to obtain a rice drink.

Vegetal milk can also be obtained by infusion or decoction of protein seeds in water.

A mixing step and/or a filtration step can be implemented at the end of the soaking, infusion or decoction step.

Thus, for the purposes of the present invention, we mean a milk obtained from cereals, a milk obtained from oleaginous fruits or a milk obtained from legumes, respectively a milk obtained by a process comprising a soaking step or an infusion step and/or a decoction step in water of cereals, oleaginous fruits and/or legumes, optionally followed by a step of mixing and/or a filtration step of the product resulting from the soaking, infusion or decoction step. The vegetal milk provides the majority of the water contained in the chocolate drink composition.

Using a vegetal milk avoids using animal milk or a product derived from such animal milk. The chocolate drink composition therefore has the advantage of being able to be consumed by people with an allergy or intolerance to dairy products.

Furthermore, it is possible in a first embodiment to choose the vegetal, in particular the oilseed fruit, the cereal or the protein legume, so that the taste of the vegetal milk is as neutral as possible. In this way, the taste of the used couverture chocolate is little modified in the chocolate drink composition.

In a particularly advantageous embodiment of the invention, the vegetal milk comprises only water and rice, the taste of which is neutral, and is suitable for this scenario.

In another embodiment, it is possible to choose the vegetal so that the taste of the vegetal milk enriches the taste of the couverture chocolate used in the beverage composition according to the invention. We can therefore consider using coconut milk to offer a chocolate drink composition in which the aromas of the coconut combine with those of the couverture chocolate.

Advantageously, vegetal milk consists only of water and vegetal.

For example, thickeners or emulsifiers other than those naturally derived from vegetals due to the steps of preparing vegetal milk from water and the concerned vegetal are not necessary here, although this is not prohibited.

In another embodiment, the vegetal milk may further comprise non-natural thickeners and/or emulsifiers, such as: a lecithin, a monoglyceride of a food fatty acid, a diglyceride of a food fatty acid, an alginate, guar gum, pectin, carrageenan.

Vegetal milk necessarily contains a certain proportion of starch, especially if the vegetal milk is a cereal. But, due to its method of preparation, particularly in the case of cereal milk by soaking, decoction or infusion of a vegetal, the starch content of a vegetal milk is generally low.

In particular, if, for the preparation of a rice-based vegetal milk, a soaking step is implemented, part of the starch naturally present in the rice is eliminated with the soaking water.

In addition, the starch present in vegetal milk is not in a gel form.

In the case of almond milk prepared with 15% by mass of powdered almonds, these almonds comprising 2.5% by mass of starch, the starch content of the vegetal milk is therefore 0.375% by mass.

The vegetal milk used for the invention may have a starch content of less than 6% by weight relative to the total weight of the vegetal milk, advantageously less than 5% by weight relative to the total weight of the vegetal milk, advantageously less than 4% by weight relative to the total weight of the vegetal milk, advantageously less than 3.9% by weight relative to the total weight of the vegetal milk, advantageously less than 3.8% by weight relative to the total weight of the vegetal milk, advantageously less than 3.6% by weight relative to the total weight of the vegetal milk, advantageously less than 3.4% by weight relative to the total weight of the vegetal milk, advantageously less than 3.3% by weight relative to the total weight of the vegetal milk, or even advantageously less than 3.2% by weight relative to the total weight of the vegetal milk.

The inventors have shown that a low starch content is sufficient to obtain the desired smooth consistency.

According to a particularly advantageous embodiment, the vegetal milk according to the invention comprises 15% by weight of rice and 84% by weight of water.

In a particular embodiment, the vegetal milk may also contain an edible vegetal oil, the content of which is less than or equal to 3% by weight, advantageously less than or equal to 2% by weight, advantageously less than or equal to 1% by weight relative to the total weight of the vegetal milk.

The edible vegetal oil can be chosen from sunflower oil, grape seed oil, rapeseed oil, sesame oil, coconut oil, olive oil, walnut oil, hazelnut oil, peanut oil or a mixture of these oils.

In a particular embodiment of the invention, the vegetal milk may also contain a flavor enhancer. Advantageously, the flavor enhancer can be salt.

Advantageously, the vegetal milk according to the invention comprises water, rice, sunflower oil and salt. Advantageously, the vegetal milk according to the invention consists of water, rice, sunflower oil and salt.

In an advantageous embodiment of the invention, the chocolate drink composition further comprises cocoa butter.

According to one embodiment, cocoa butter can be added to the chocolate drink composition according to the invention comprising the couverture chocolate and the vegetal milk. The addition of cocoa butter will depend on the used couverture chocolate.

If cocoa butter is added to the chocolate drink composition according to the invention, the content of cocoa butter added is at least 0.5% by weight, advantageously at least 1.0% by weight, advantageously at least 1.5% by weight, advantageously at least 2.0% by weight, advantageously at least 2.5% by weight, advantageously at least 3.0% by weight, advantageously at least 3.5% by weight, advantageously at least 4.0% by weight, advantageously at least 4.5% by weight, advantageously at least 5.0% by weight, advantageously at least 5.5% by weight, advantageously at least 6.0% by weight, advantageously at least 6.5% by weight, advantageously at least 7.0% by weight, advantageously at least 7.5% by weight, advantageously at least 8.0% by weight, advantageously at least 8.5% by weight, advantageously at least 9.0% by weight, advantageously at least 9.5% by weight, advantageously at least 10.0% by weight, advantageously at least 10.5% by weight, advantageously at least 11.0% by weight, advantageously at least 11.5% by weight, advantageously at least 12.0% by weight, advantageously at least 12.5% by weight, advantageously at least 13.0% by weight, advantageously at least 13.5% by weight, preferably at least 14.0% by weight, preferably at least 14.5% by weight, preferably at least 15.0% by weight relative to the total weight of the chocolate drink composition.

Advantageously, the content of cocoa butter added to said chocolate drink composition is between 0.5% by weight and 15.0% by weight, advantageously between 1.0% by weight and 13.0% by weight, advantageously between 1.5% by weight and 10.0% by weight, advantageously between 2.0% by weight and 5.5% by weight, advantageously between 2.5% by weight and 4.5% by weight, advantageously between 2.5% by weight and 4.0% by weight, advantageously between 2.5% by weight and 3.5% by weight relative to the total weight of the chocolate drink composition. Advantageously, the content of cocoa butter added to said chocolate drink composition is 3.0% by weight relative to the total weight of the chocolate drink composition.

In a particular embodiment of the invention, the chocolate drink composition comprises:
between 33% and 50% by weight of couverture chocolate,
between 0.5% and 15.0% by weight of cocoa butter, and
between 50% and 60% by weight of vegetal milk.

In a particular embodiment of the invention, the chocolate drink composition further comprises at least one additional agent chosen from a sweetening agent, a flavoring agent, a flavor enhancer and a mixture of these.

Advantageously, the chocolate drink composition may comprise a sweetening agent, that is to say an agent having a sweetening power, inherently present in the vegetal milk or added to the chocolate drink composition according to the invention. By way of non-limiting example, the sweetening agent may be glucose, fructose, sucrose, maltose, lactose, sorbitol, maltitol, mannitol, honey, agave syrup or even a sweetener, including sucralose, stevia, sorbitol, maltitol, lactitol, xylitol or isomalt.

The addition of a sweetening agent can in particular be considered in the case where the cocoa content of the couverture chocolate is high, for example greater than 70%, for example greater than 80%.

Advantageously, the chocolate drink composition may comprise a flavoring agent.

Advantageously, the flavoring agent can be a natural or artificial flavoring substance or even a flavoring preparation. By flavoring preparation, within the meaning of the present invention, is meant a fruit coulis, citrus zest, or even an oilseed powder or a dried fruit paste.

In a particular embodiment, the flavoring preparation may comprise cocoa butter.

For example, liquid vanilla extract, vanilla powder, natural or synthetic vanilla flavor or even a food alcohol can be used as a flavoring agent. Spices such as pepper, cinnamon, chili, or mint, or even a liquid coffee extract can be used as a flavoring agent.

It is also possible, always with a view to superimposing tastes on the basis of the chocolate taste that one wishes to express in the drink, to add to the chocolate drink composition according to the invention a flavoring preparation, such as a fruit coulis, citrus zest, a fruit essential oil or even an oilseed fruit powder or a dried fruit paste, spices such as pepper, cinnamon, chili, or mint, or even a liquid coffee extract.

In this case, less than 50 g of flavoring preparation will typically be added per 1 kg of chocolate drink composition according to the invention. In this case, it is possible to add an appropriate quantity of water, for example mineral water, so as to take into account the impact of the flavoring preparation on the final consistency of the chocolate drink composition according to the invention.

In one embodiment, the quantity of water to be added is advantageously less than 50 mL per 1 kg of chocolate drink composition, advantageously less than 40 mL per 1 kg of chocolate drink composition, advantageously less than 30 mL for 1 kg of chocolate drink composition, advantageously less than 20 mL per 1 kg of chocolate drink composition, advantageously less than 10 mL per 1 kg of chocolate drink composition.

Optionally an appropriate quantity of a flavor enhancer can be added to the chocolate drink composition according to the invention.

It is thus possible to add salt to the chocolate drink composition according to the invention, for example in the form of fleur de sel. For example, we could add a mass of between 0 to 3 g of salt per 1 kg of chocolate drink composition according to the invention.

The salt content of the chocolate drink composition is advantageously between 0 and 2 g of salt per 1 kg of chocolate drink composition, advantageously between 0 and 1 g of salt per 1 kg of chocolate drink composition.

In one embodiment of the present invention, the chocolate drink composition is free of milk and/or milk derivatives of animal origin.

In one embodiment of the present invention, the viscosity of the chocolate drink composition is between 150 mPa·s and 500 mPa·s, said viscosity being measured at 70° C.

Advantageously, the viscosity is a dynamic viscosity. Advantageously, the viscosity measured at 70° C. is between 150 mPa·s and 400 mPa·s, advantageously between 150 mPa·s and 300 mPa·s, advantageously between 150 mPa·s and 250 mPa·s, advantageously between 150 mPa·s .s and 240 mPa·s, advantageously between 150 mPa·s and 230 mPa·s, advantageously between 150 mPa·s and 220 mPa·s, advantageously between 155 mPa·s and 210 mPa·s.

Advantageously, the inventors have shown that the particular composition of the chocolate drink composition as well as the ratio between the contents of couverture chocolate and vegetal milk, in combination with a particular maximum temperature reached during the preparation of the chocolate drink composition, make it possible to obtain a very particular viscosity at a temperature of 70° C., which can be associated with the smoothness perceived by the consumer despite the absence of products derived from animal milk.

Furthermore, the inventors have shown that this viscosity is both higher than those of commercially available milk chocolate drinks, even those comprising a significant proportion of cream, and much lower than those of chocolate drinks made from vegetal milk from US patent application 2011/0274813 perceived as pasty rather than smooth.

In one embodiment of the present invention, the viscosity of the chocolate drink composition is between 1500 mPa·s and 3000 mPa·s, the viscosity being measured at 25° C.

Advantageously, the viscosity is a dynamic viscosity Advantageously, the viscosity measured at 25° C. is between 1500 mPa·s; 2500 mPa·s, advantageously between 1500 mPa·s and 2300 mPa·s, advantageously between 1700 mPa·s and 2300 mPa·s, advantageously between 1750 mPa·s and 2250 mPa·s.

Another aspect of the invention relates to a process for preparing a chocolate drink composition according to the invention described above. This process comprises the following steps consisting of:
a) mixing at least the couverture chocolate and the vegetal milk,
b) heating the mixture obtained in step a) to a temperature of at least 75° C.,
c) homogenizing the blend.

Advantageously, step a) may further comprise the addition of cocoa butter and/or at least one additional agent chosen from a sweetening agent, a flavoring agent, and/or at least one flavor enhancer and a mixture of these with chocolate couverture and vegetal milk.

Advantageously, step a) is carried out at room temperature.

Advantageously, step b) of heating the mixture is carried out at a temperature of at least 75° C.

It is noted in particular by comparing sample 8 of example 5 with sample 2 of example 1 that the maximum temperature reached during the process of preparing the chocolate drink composition, all other things being equal, is essential to obtain the desired viscosity at 70° C. In particular, a heating temperature in step b) of 70° C. in combination with a proportion of couverture chocolate equal to 33% by mass does not make it possible to obtain the desired viscosity at 70° C.

It is therefore the combination of a sufficient content of couverture chocolate, that is to say at least 33% by mass, and a sufficient heating temperature during the process of preparing the composition of chocolate drink, that is to say at least 75° C., which makes it possible to obtain the desired viscosity so that the chocolate drink composition is perceived as smooth at a consumption temperature of 70° C.

Advantageously, the heating temperature of step b) is at least 75° C., advantageously at least 78° C., advantageously at least 80° C., advantageously at least 85° C., advantageously at least 90° C., advantageously at least 91° C., advantageously at least 92° C., advantageously at least 93° C., advantageously at least 94° C., advantageously at least 95° C., advantageously at least 96° C., advantageously at least 97° C., advantageously at least 98° C., advantageously at least 99° C. Advantageously, the heating temperature of step b) is between 75° C. and 99° C., advantageously between 75° C. and 99° C., advantageously between 75° C. and 95° C., advantageously between 75° C. and 85° C., advantageously between 85° C. and 90° C., advantageously between 90° C. and 95° C. Advantageously, the heating temperature of step b) is strictly less than 100° C. Above 100° C., the texture of the chocolate drink thickens excessively, a burnt taste may appear and the emulsion becomes unstable.

In a particularly advantageous embodiment of the invention, the temperature of step b) is between 90° C. and 95° C. if the ratio R is between 1.75 and 1.85. This is the procedure that was chosen to prepare sample 2.

In another particularly advantageous embodiment of the invention, the temperature of step b) is between 80° C. and 85° C. if the ratio R is between 1.55 and 1.65. This is the procedure that was chosen to prepare samples 1 and 6.

Generally speaking, the choice of temperature for step b) depends on the proportion of water by weight in the initial mixture. The higher the water content (m/m) in the initial mixture, the higher the temperature of step b) must be, all other things being equal, in order to obtain the desired smooth consistency.

Advantageously, step b) of heating the mixture is carried out at a temperature of at least 80° C. Step c) of the process consists of homogenizing the mixture, preferably continuously during the rise in temperature, so as to constantly obtain a temperature that is as homogeneous as possible in the mixture and to promote obtaining the emulsion.

Preferably, the mixture is homogenized with a rotating device, manual or electric, whose rotation speed is less than or equal to 60 revolutions per minute. A person skilled in the art will be able to adapt the duration of step c) of homogenization according to the quantity of mixture.

The chocolate drink composition can then either be consumed directly, after cooling to a temperature below 70° C., in particular to avoid any risk of burning.

The chocolate drink composition can also be poured into a storage container (bottle-for example glass bottle, cardboard brick, etc.), preferably sterilized beforehand. The container can advantageously be closed hermetically immediately after filling.

The chocolate drink composition is then allowed to cool to room temperature.

At room temperature, the chocolate drink composition is a macroscopically homogeneous emulsion.

At a temperature above 6° C., up to the maximum temperature reached during heating, the chocolate drink composition is in fact a macroscopically homogeneous emulsion, that is to say it does not “slice” or does not “seed” and this emulsion is kinetically stable, with a shelf life of around several weeks.

No flocculation, coalescence, sedimentation or graining is observed, nor due to cooling to a temperature above 6° C. or heating to a temperature below the maximum heating temperature during the preparation of the chocolate drink composition, nor after storage at 6° C. for at least eight weeks.

The chocolate drink composition can thus be kept for several weeks in the refrigerator. In particular, we observe that the macroscopic homogeneity of the emulsion observed with the naked eye is preserved after at least eight weeks of storage at 6° C.

This stability is due to the method of preparation of the chocolate drink composition and to its composition, which does not include any emulsifier other than those present in the couverture chocolate used.

After storage, the chocolate drink composition can be consumed as is or after reheating, for example over moderate heat, in a bain-marie or in a microwave oven.

### EXAMPLES

### Example 1: Preparation of Samples

Six samples, numbered 1 to 6, were prepared to then be analyzed quantitatively in terms of viscosity and color, and qualitatively with a test panel of consumers.

Samples 1, 2 and 6 are chocolate drinks according to the invention.

Samples 3 and 4 are two chocolate drinks comprising commercially available milk of animal origin or a product derived from milk of animal origin.

Sample 5 reproduces the chocolate drink of example 3 of American patent application US 2011/0274813 A1, this drink not including milk of animal origin or product derived from milk of animal origin.

### 1. Sample 1 “Classic—35.7%-80° C.”:

We mix 3.968 kg of dark couverture chocolate with 72% cocoa from the Clavileno® brand (reference 72), 7.142 kg of “rice drink” from the Yosoy® brand (composition: water, 15% rice, sunflower oil, 0.7 g/L of sea salt; fat content 10 g/L; sugar content: 109 g/L including 50 g of sugars) and 6.6 g of salt and with constant stirring, the mixture is brought to a temperature between 80° C. and 85° C. Once this temperature is reached, the temperature is maintained at this temperature for one minute.

Then the mixture is placed in its final container and allowed to cool to room temperature.

### 2. Sample 2 “Gourmet 72—38%-80° C.”:

We mix 4.273 kg of dark couverture chocolate with 72% cocoa from the Clavileno® brand (reference 72), 6.837 kg of “rice drink” from the Yosoy® brand (composition: water, 15% rice, sunflower oil, 0.7 g/L of sea salt; fat content 10 g/L; sugar content: 109 g/L including 50 g of sugars) and 6.6 g of salt and with constant stirring, the mixture is brought to a temperature between 80° C. and 85° C. Once this temperature is reached, the temperature is maintained at this temperature for one minute.

Then the mixture is placed in its final container and allowed to cool at room temperature.

### 3. Sample 3: Celaya® Hot Chocolate

Sample 3 is a Celaya® Hot Chocolate from the Valrhona® brand, whose batch number is T 078 A 302 0 16:01 032 and the minimum durability date (MBD): Aug. 27, 2021 (Produced on 28 Oct. 2020)

4. Sample 4: Old-fashioned hot chocolate from the Angelina® brand;) Sample 4 is an old-fashioned hot chocolate in a 48 cL bottle from the Angelina® brand, whose batch number is A1 J333 and the date of minimal durability DDM Nov. 29, 2021 (Produced Nov. 29, 2019).
5. Sample 5: Chocolate drink according to example 3 of American patent application US 2011/0274813

Ingredients of sample 5:425 g of water; 25 g of rice starch; 100 g of cocoa; 209.5 g of sugar; 162.5 g of palm oil; 2.5 g of soy lecithin.

Procedure for preparing sample 5:

The chocolate mass, including cocoa, sugar, palm oil and lecithin, is melted at a temperature below 65° C. The rice starch gel, formed from water and rice starch, is heated to 80° C. and gradually added to the chocolate mass over a total addition time of 15 minutes. The mixture is then homogenized for 3 minutes at 80° C. and finally pasteurized at 85° C.

### 6. Sample 6 “Gourmet Orange—38%-80° C.”:

We mix 4.273 kg of dark couverture chocolate with 72% cocoa from the Clavileno® brand (reference 72), 6.837 kg of “rice drink” from the Yosoy® brand (composition: water, 15% rice, sunflower oil, 0.7 g/L of sea salt; fat content 10 g/L; sugar content: 109 g/L including 50 g of sugars) and 6.6 g of salt and with constant stirring, the mixture is brought to a temperature between 80° C. and 85° C. Once this temperature is reached, the temperature is maintained at a temperature between 80° C. and 85° C. for one minute. Add the zest of two medium-sized oranges, then leave to infuse for 10 minutes at 80° C. The mixture is then filtered and placed in its final container in which it is allowed to cool at room temperature.

### Example 2: Measurement of Viscosity

The viscosity measurements as a function of temperature were carried out on a Rapid Visco Analyzer® model super 4 (RVA-4) measuring device manufactured by the company Newport Scientific.

A mass m equal to 28.5 g of the sample to be tested is placed in the measuring device. This mass is homogenized mechanically by the measuring propeller. The mass m is subjected to the heating and cooling stages described in table 1 which follows:

TABLE 1
Operating conditions for viscosity measurements

| | | | Propeller | |
|---|---|---|---|---|
| | Starting | End | speed | Temperature |
| | time | time | (rpm) | (° C.) |
| Initial | 0 min 0 s | 0 min 15 s | 960 | 25 |
| Homogeneisation | | | | |
| Viscosity | 0 min 15 s | 5 min 15 s | 160 | 25 |
| measurement at | | | | |
| ambient T (25° C.) | | | | |
| Temperature rise | 5 min 15 s | 8 min 15 s | 160 | From 25 to 70 |
| Viscosity | 8 min 15 s | 13 min 15 s | 160 | 70 |
| measurement at | | | | |
| Tmax (70° C.) | | | | |
| Temperature fall | 13 min 15 s | 20 min 15 s | 160 | From 70 to 30 |
| Stabilisation | 20 min 15 s | 22 min 15 s | 100 | 30 |

The dynamic viscosity is measured every two seconds during the measurement phases at ambient temperature (Tambiant=25° C.) and at elevated temperature (Tmax=70° C.). Table 2 groups together the average values of the viscosities measured for the five samples at the two temperatures Tambiant (25° C.) and Tmax, (70° C.) as well as the corresponding standard deviation.

TABLE 2
Viscosity of samples 1 to 5 at 25° C. and 70° C.

| | Viscosity at 25° C. | Viscosity at 70° C. |
|---|---|---|
| | (centipoise, cp) | (centipoise, cp) |
| Sample 1 | 1796.5 (+/− 17.66) | 157.55 (+/− 5.35) |
| Sample 2 | 2211.5 (+/− 94.2) | 199.3 (+/− 12.8) |
| Sample 3 | 311.75 (+/− 5.05) | 57.55 (+/− 1.65) |
| Sample 4 | 1404.1 (+/− 28.34) | 64.55 (+/− 4.75) |
| Sample 5 | 1335.25 (+/− 30.15) | 530.55 (+/− 6.25) |

We see in Table 2 that the choice of ingredients and their proportions (including a ratio of the initial masses of vegetal drink and chocolate of between 1.2 and 2 for samples 1, 2 and 6) as well as the particular operating mode for the preparation of the drink, including precise control of the maximum temperature reached as a function of the ratio R, make it possible to obtain a very specific range of dynamic viscosity at a temperature of 70° C., which can be associated with the smoothness perceived by the consumer despite the absence of products derived from an animal milk.

This viscosity is both higher than that of commercially available milk chocolate drinks, even those comprising a significant proportion of cream (samples 3 and 4 of Example 1), and much lower than that of vegetal milk chocolate drinks of the prior art (sample 5), perceived as pasty rather than smooth.

The method of preparing rice milk used for Examples 1 and 2 thus makes it possible to obtain a chocolate drink composition whose dynamic viscosity measured at 20° C. is greater than that of the drink of the prior art formed from of a rice starch gel corresponding to sample 5 of example 1) but a dynamic viscosity measured at 70° C. two to three times lower than sample 5.

We know in fact that, if it is known to use starch from a vegetal to thicken a preparation, for this thickening power to be best expressed, it is necessary to be at an optimal cooking level. and to have optimal proportions of water and starch. Indeed, if the starch is undercooked, the starch grains are not sufficiently swollen. As a result, not only will the texture be too liquid, but there will be appearance and bonding defects. On the other hand, if the starch grains are overcooked, there will be a risk of separation of the phases of the mixture, with a mixture that slices.

We can be convinced of this on the basis of the results of a study concerning the consistency of the chocolate drink composition according to the invention, compared to that of chocolate drinks of the prior art in tables 4 and 5 of the example 4 below.

### Example 3: Color Measurement

Color measurements are carried out on a Konica Minolta® brand CR-400 colorimeter, in the L*a*b CIE 1976 color space. At least three measurement repetitions are carried out for each sample.

$$ΔE = √ [ {( Δ L )}^{2} + {( Δ a )}^{2} + {( Δ b )}^{2} ] \qquad Formula 1$$

Table 3 groups together the colors measured for the five samples, with the corresponding standard deviation, at the two temperatures Tambiant=25° C. and Tmax=70° C., as well as the color difference ΔE for each sample between these two temperatures.

TABLE 3
color of samples 1 to 5 at 25° C. and 70° C. in color
space L*a*b CIE 1976

| | Temper- | | | | |
|---|---|---|---|---|---|
| Sample | ature | L*(C) | a*(C) | b*(C) | ΔΕ |
| 1 | 25° C. | 36.38 ± 0.23 | 10.67 ± 0.11 | 16.26 ± 0.13 | |
| | 70° C. | 26.46 ± 0.01 | 11.82 ± 0.01 | 8.63 ± 0.02 | 12.57 |
| 2 | 25° C. | 35.56 ± 0.13 | 10.85 ± 0.05 | 15.32 ± 0.12 | |
| | 70° C. | 26.34 ± 0.05 | 11.98 ± 0.01 | 8.73 ± 0.03 | 11.39 |
| 3 | 25° C. | 39.74 ± 0.05 | 10.47 ± 0.006 | 15.02 ± 0.03 | |
| | 70° C. | 37.58 ± 0.27 | 10.49 ± 0.012 | 13.96 ± 0.17 | 2.41 |
| 4 | 25° C. | 41.59 ± 0.44 | 8.64 ± 0.38 | 16.88 ± 0.56 | |
| | 70° C. | 32.54 ± 0.32 | 8.72 ± 0.6 | 11.22 ± 0.48 | 10.67 |
| 5 | 25° C. | 22.9 ± 0.07 | 11.32 ± 0.04 | 4.52 ± 0.02 | |
| | 70° C. | 20.27 ± 0.03 | 11.25 ± 0.03 | 2.05 ± 0.04 | 3.61 |

In addition to its taste and texture, the chocolate drink composition is distinguished from the commercial drinks corresponding to samples 3 and 4 of example 1 and from the prior art corresponding to sample 5 of this same example by the amplitude of the color variation between its color in the L*a*b CIE 1976 color space, greater than 11.

### Example 4: Test on a Panel of Consumers

A sample of N (N=52 or N=46 depending on the case, see table 4 below) consumers proceeds, blindly and successively, to the tasting of at least two different samples brought to a temperature of 70° C. Each consumer must answer the following questions by choosing one of the answers proposed:
1) how do you judge the consistency:
   too liquid
   just right
   too creamy
2) how do you judge the sensation in the mouth:
   bad
   mediocre
   average
   Good
   excellent

Table 4 brings together the results of a first survey on a panel of N consumers concerning consistency for sample 1 (classic) and sample 2 (gourmet), in terms of percentage of responses expressed.

TABLE 4
results of the consumer survey about consistency
of the sample 1, 2 and 6 according to the invention

| | Sample 1 | Sample 2 | Sample 6 |
|---|---|---|---|
| N | 52 | 52 | 46 |
| Too liquid | 0% | 0% | 0% |
| Just right | 62.5% | 50% | 75% |
| Too creamy | 37.5% | 50% | 25% |

Table 5 brings together the results of a second survey on a panel of 15 consumers concerning the consistency for sample 1 (classic) and sample 2 (gourmet), sample 4 (from the Angelina® brand) and sample 5 (reproduction of example 3 of American patent application US 2011/0274813 A1), in terms of percentage of responses expressed.

TABLE 5
Results of the consumer survey on the consistency
of samples 1, 2, 4 and 5

| | Sample 1 | Sample 2 | Sample 4 | Sample 5 |
|---|---|---|---|---|
| N | 15 | 15 | 15 | 15 |
| Too liquid | 13.3% | 0% | 33.3% | 0% |
| Just right | 86.7% | 50% | 33.3% | 13.3% |
| Too creamy | 0% | 50% | 33.3% | 86.7% |

We see in Table 4 that the consistency of the so-called “classic” sample 1 is rated “just right” by 62.5% of consumers. The consistency of samples 2 “gourmet” and 6 “gourmet orange” and is rated “just right” by 50% and 75% of consumers, respectively. These results prove that the composition consistency of the chocolate drink composition according to the invention conforms to the consistency sought by a majority of consumers, which is confirmed by the results presented in Table 5, in which the consistency of the sample 1 “classic” is rated “just right” by 86.7% of consumers. The consistency of sample 2 “gourmet” is rated “just right” by 50%.

These results are much higher than those obtained by sample 5 reproducing example 3 of American patent application US 2011/0274813 A, for which consistency is noted as “just right” by only 13.3% of the consumers.

The consistency of sample 5 is considered “too creamy” by 86.7% of consumers while that of sample 1 is not considered “too creamy” by any of the consumers, confirming that the procedure followed to prepare the invention does not lead to the same consistency as the use of a starch gel.

The composition consistency of the chocolate drink composition according to the invention is therefore judged to conform to the consistency sought by a majority of consumers and by a proportion of consumers greater than that of chocolate drinks of the prior art.

Table 6 brings together the results of the survey on a panel of N=42, 37 or 46 consumers concerning the sensation in the mouth for sample 1 (classic) and sample 2 (gourmet), in terms of percentage of responses expressed.

TABLE 6
Results of the consumer survey on the sensation in
mouth of samples 1, 2 and 6 following the invention

| | Sample 1 | Sample 2 | Sample 6 |
|---|---|---|---|
| N | 42 | 37 | 46 |
| Bad | 0% | 0% | 0% |
| Mediocre | 0% | 0% | 0% |
| Average | 12.5% | 0% | 6.25% |
| Good | 31.25% | 65.3% | 43.75% |
| excellent | 56.25% | 35.7% | 50% |

Table 7 brings together the results of a second survey on a panel of N=15 consumers concerning the sensation in the mouth for sample 1 (classic) and sample 2 (gourmet), sample 4 (from the Angelina brand®) and sample 5 (reproduction of example 3 of American patent application US 2011/0274813 A1), in terms of percentage of responses expressed.

TABLE 7
results of the consumer survey on the sensation
in mouth of samples 1, 2, 4 and 5

| | Sample 1 | Sample 2 | Sample 4 | Sample 5 |
|---|---|---|---|---|
| N | 15 | 15 | 15 | 15 |
| Bad | 0% | 0% | 0% | 53.3% |
| Mediocre | 0% | 6.7% | 20% | 6.7% |
| Average | 6.7% | 6.7% | 20% | 0% |
| Good | 60% | 26.4% | 40% | 20% |
| excellent | 33.3% | 60% | 20% | 20% |

The sensation in mouth of sample 1, called “classic”, corresponding to an intense chocolate taste, is rated good or excellent by 93.3% of consumers in the second survey (table 7) and by 87.5% of consumers in the first survey (table 6). The sensation in mouth of sample 2, corresponding to a very intense chocolate taste, was rated as good or even excellent by 86.4% of consumers in the second survey (Table 7) and by 100% of consumers in the first survey (table 6).

These results are much higher than those obtained by sample 4, from the market, for which the sensation in mouth is rated good or excellent by only 60% of consumers.

These results are also much higher than those obtained by sample 5 reproducing example 3 of American patent application US 2011/0274813 A, for which the sensation in mouth is rated good or even excellent by only 40% of consumers and is even considered bad by 53.3% of consumers.

The sensation in mouth obtained with the chocolate drink composition and its preparation process is therefore significantly different from that of chocolate drinks of the prior art and advantageous compared to the latter.

### Example 5: Comparative Test-Influences of the Proportion of Couverture Chocolate and the Heating Temperature

To confirm that it is the combination of a particular content of couverture chocolate and a particular heating temperature of the mixture which allows to obtain the desired viscosity at 70° C., two additional samples were prepared and tested, for comparison with samples 1 and 2.

### 1. Sample 7 “Comparative—33%- 70° C.”:

We mix 4.273 kg of dark couverture chocolate with 72% cocoa from the Clavileno® brand (reference 72), 8.675 kg of “rice drink” from the Yosoy® brand (composition: water, 15% rice, sunflower oil, 0.7 g/L of sea salt; fat content 10 g/L; sugar content: 109 g/L including 50 g of sugars) and 6.6 g of salt and with constant stirring, the mixture is brought to a temperature equal to 70° C. Once this temperature is reached, the temperature is maintained at this temperature for one minute. Then the mixture is placed in its final container and allowed to cool to room temperature.

### 2. Sample 8 “Comparative2—25%-80° C.”:

We mix 4.273 kg of dark couverture chocolate with 72% cocoa from the Clavileno® brand (reference 72), 12.819 kg of “rice drink” from the Yosoy® brand (composition: water, 15% rice, sunflower oil, 0.7 g/L of sea salt; fat content 10 g/L; sugar content: 109 g/L including 50 g of sugars) and 6.6 g of salt and with constant stirring, the mixture is brought to a temperature equal to 80° C. Once this temperature is reached, the temperature is maintained at this temperature for one minute. Then the mixture is placed in its final container and allowed to cool to room temperature.

The viscosities of samples 7 “comparative1” and 8 “comparative2” are measured following the measurement procedure described in Example 2.

Table 8 groups together the average values of viscosities measured for samples 7 and 8, as well as for samples 1 and 2, at temperature Tmax, (70° C.) t.

TABLE 8
Viscosity of samples 1, 2, 7 and 8
at 25° C. and 70° C.

| | Viscosity at 70° C. |
|---|---|
| | (centipoise, cp) |
| Sample 1 | 157.55 |
| Sample 2 | 199.3 |
| Sample 7 | 110.8 |
| Sample 8 | 11.21 |

### Conclusion

It is noted by comparing sample 8 to sample 1 or sample 2 that a proportion of chocolate less than 33% with the same heating conditions during the preparation of the chocolate drink composition as for samples 1 and 2 does not make it possible to obtain the desired viscosity at 70° C., the result obtained for sample 8 having too low viscosity to be perceived as smooth. We also note by comparing sample 7 to samples 1 and 2 that a proportion of chocolate equal to 33% but with a maximum temperature reached during the manufacturing process of the composition equal to 70° C., therefore lower than those of the samples 1 and 2, does not make it possible to obtain the desired viscosity range.

1. Composition of chocolate drink, wherein the composition comprises:
at least 33% by weight of couverture chocolate, and
at least 50% by weight of a vegetal milk,
said chocolate drink composition having a viscosity measured at 70° C. of between 150 mPa·s and 500 mPa·s.

2. Chocolate drink composition according to claim 1, in which the couverture chocolate has a cocoa content of at least 40%.

3. Chocolate drink composition according to claim 1, in which the vegetal milk is chosen from a milk obtained from cereals, a milk obtained from oleaginous fruits, a milk obtained from legumes, or a mixture of these.

4. Chocolate drink composition according to claim 1, in which the vegetal milk is a milk obtained from cereals, with the exception of soy milk.

5. A chocolate drink composition according to claim 4, wherein the cereal milk comprises at least 10% by weight of cereal and at least 80% by weight of water.

6. Chocolate drink composition according to claim 1, comprising:
between 33% and 45% by weight of couverture chocolate, and
between 50% and 70% by weight of vegetal milk.

7. A chocolate drink composition according to claim 1, wherein the chocolate drink composition further comprises cocoa butter.

8. Chocolate drink composition according to claim 1, further comprising at least one additional agent chosen from a sweetening agent, a flavoring agent, a flavor enhancer and a mixture thereof.

9. A chocolate drink composition according to claim 1, wherein said chocolate drink composition is free of milk and/or milk derivatives of animal origin.

10. Chocolate drink composition according to claim 1, said chocolate drink composition having a dynamic viscosity measured at 25° C. is between 1500 mPa·s and 3000 mPa·s.

11. Process for preparing a chocolate drink composition, wherein the process comprises the steps consisting of:
a) mixing at least one couverture chocolate and a vegetal milk, so that an obtained mixture comprises at least 33% by weight of couverture chocolate and at least 50% by weight of vegetal milk,
b) heating the mixture obtained in step a) to a temperature of at least 75° C.,
c) homogenizing the mixture.
